(19) United States
(12) Patent Application Publication
(10) Pub. No.: US 2024/0353044 A1
(43) Pub. Date: Oct. 24, 2024

(54) WATER HAMMER ABSORPTION DEVICE AND MANUFACTURING METHOD OF SAME

(71) Applicant: RICH FULL HARDWARE CO., LTD., Changhua County (TW)

(72) Inventor: CHIA-HAN HSIEH, Changhua County (TW)

(21) Appl. No.: 18/138,724

(22) Filed: Apr. 24, 2023

(51) Int. Cl. F16L 55/055; F16L 55/053

(52) U.S. Cl. CPC F16L 55/055; F16L 55/053

(57) ABSTRACT

A water hammer absorption device is provided with a movable water plug inside a water hammer pipe; the both ends of the water hammer pipe are respectively connected with a joint and cover, where the joint is connected to a connecting pipe, and the cover closes the water hammer pipe, it is characterized in that the inside of the water hammer pipe opposite to the joint is provided with non-return diaphragm adapted to close the internal part of the water hammer pipe, the non-return diaphragm prevents the high-pressure air from leaking out, and the side of the water hammer pipe having the non-return diaphragm is closed through the cover to strengthen the airtightness of the internal space.

### (a) TECHNICAL FIELD OF THE INVENTION

The present invention relates to a water hammer absorption device, mainly using a non-return diaphragm on the side of the device where the high-pressure air is injected, so as to simplify the structure of the water hammer absorption device and achieve the manufacturing and using convenience.

### (b) DESCRIPTION OF THE PRIOR ART

In the pressure pipeline, due to the change of the liquid flow rate, the liquid pressure in the pipe has significant and repeated changes, and the hammering phenomenon occurs on the pipeline. Since the pressure in the pipeline is increased, it will exceed the normal pressure in the pipe, and the repeatedly changed pressure forms the pulse with damaging force, which causes vibration and noise in the pipeline and equipment.

To solve the above noise and vibration problems, one side of the inlet pipe is equipped with a water hammer absorber, the structure of which fundamentally has a hollow pipe body, piston, joint and cover.

Upon manufacturing, the piston is assembled with the hollow pipe body, and the joint and cover are next respectively provided on the two ends of the hollow pipe body. Furthermore, the joint is used to install the water hammer absorber on an inlet pipe; one end of the cover is further provided with an air nozzle, which can be operated in coordination with a spring to inject high pressure air into the hollow pipe body from one side of the air nozzle. When the high-pressure air is removed from one side of the air nozzle, the spring rebounds to close the air nozzle.

However, the conventional product has the following disadvantages:
1. the air nozzle is apt to be collided to damage to cause the air to leak since the air nozzle is exposed outside the cover; and
2. the water hammer absorber will fail after the high-pressure air leaks out since the structure of the water hammer absorber of the air nozzle is relatively complicated, and the spring will have the problem of elastic fatigue.

### SUMMARY OF THE INVENTION

The main object of the present invention is to provide a water hammer absorption device, using a non-return diaphragm to replace the original air nozzle, allowing the water hammer absorption device to have no a exposed air nozzle, and preventing operation collision to damage. In addition, the non-return diaphragm is low in cost and easy in assembly, and can greatly simplify the structure of the water hammer absorption device.

To achieve the above object, the present invention proposes a water hammer absorption device, provided with a movable water plug slidable inside a water hammer pipe, both ends of the water hammer pipe respectively in connection with a joint and cover, the joint adapted to be connected with a connecting pipe, and the cover closing the water hammer pipe, characterized in that: a bottom wall is provided inside the side of the water hammer pipe opposite to the joint, the bottom wall is provided with a mounting hole and a plurality of filling holes, a non-return diaphragm is assembled inside the water hammer pipe, the non-return diaphragm is adapted to shield the filling holes of the bottom wall of the water hammer pipe, and the non-return diaphragm is provided with a rod configured in the mounting hole; high-pressure air is removed after injected into an internal space of the water hammer pipe, allowing high pressure to be generated inside the water hammer pipe, and the non-return diaphragm to attach to and cover the bottom wall and the plurality of filling holes, preventing the high-pressure air from leaking out, and closing the side of the water hammer pipe having non-return diaphragm through the cover, thereby strengthening the airtightness of the internal space.

According to the device mentioned above, the movable water plug is sleeved with a plurality of water-stop rubber rings.

According to the device mentioned above, the joint is connected to the water hammer pipe by means of rotary welding, welding or screwing.

According to the device mentioned above, the joint is provided with a turn part allowing the joint to be turned to fix to the connecting pipe with a wrench or tool.

The present invention further proposes a method for manufacturing the water hammer absorption device, including the following steps:
inserting non-return diaphragm into the water hammer pipe from the side thereof opposite to the bottom wall, and sleeving the rod of the non-return diaphragm in the mounting hole;
inserting the movable water plug into the water hammer pipe from the side opposite to the bottom wall;
assembling and fixing the joint to the side of the water hammer pipe opposite to the bottom wall;
injecting high-pressure air into the interspace of the water hammer pipe from the plurality of filling holes, and thereafter, removing the high-pressure air from the plurality of filling holes, allowing the internal space to generate an air chamber effect to cause the non-return diaphragm to be deformed to attach to the bottom wall 11, preventing the high-pressure air of the internal space form leaking out; and
assembling and fixing the cover to the side of the water hammer pipe opposite to the joint, so that the assembly of the water hammer absorption device can then be completed.

The present invention has the following advantages compared to the prior art:
1. the present invention has no design such as air nozzle, greatly simplifying the structure of the water hammer absorption device;
2. the present invention uses the design of the non-return diaphragm, not easily generating elastic fatigue, and preventing the high-pressure air from leaking out to cause the failure of the water hammer absorption device; and
3. the present invention is low in production cost, and highly reliable in quality.

### BRIEF DESCRIPTION OF THE DRAWINGS

FIG. 1 shows a structure of the present invention;

FIG. 2 is an exploded view of the structure of the present invention;

FIG. 3 is a cross-sectional view of the structure of the present invention; and

FIGS. 4 to 7 respectively show a manufacturing process of the present invention.

### DETAILED DESCRIPTION OF THE PREFERRED EMBODIMENTS

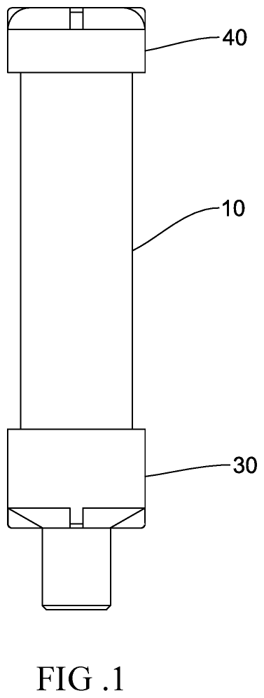

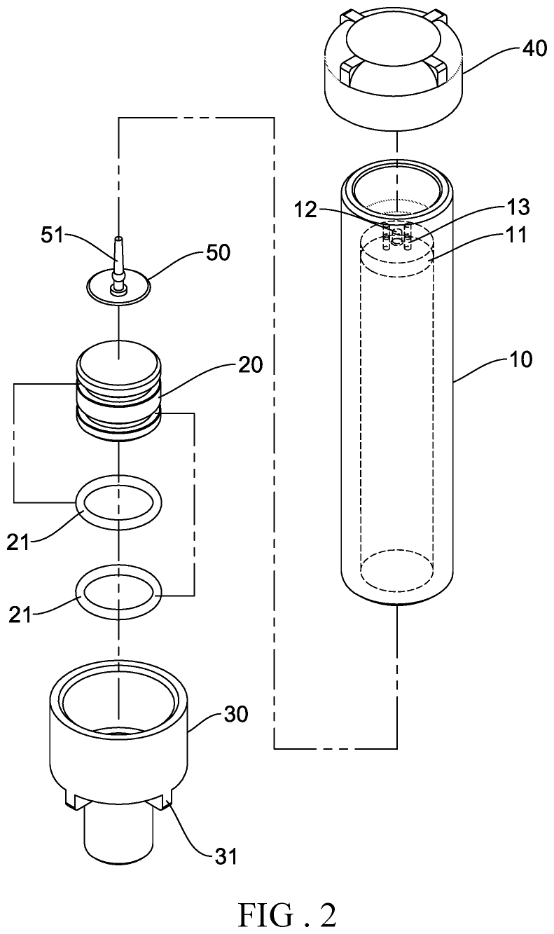

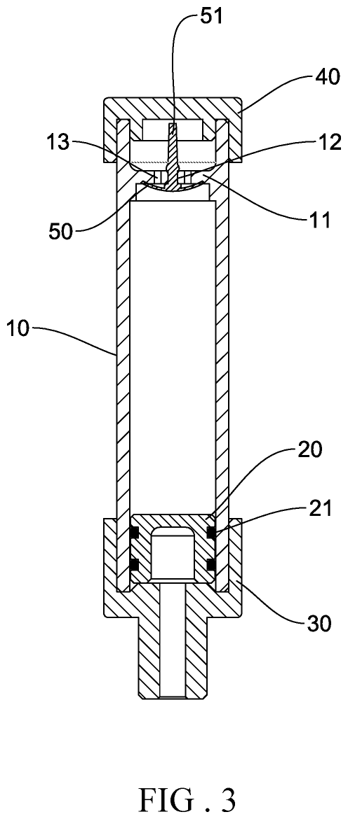

Referring to FIGS. 1 to 3, a water hammer absorption device of the present invention is provided with an movable water plug 20 slidable within a water hammer pipe 10, and the both ends of the water hammer pipe 10 are respectively connected with a joint 30 and cover 40, where the joint 30 is used to connect to a connecting pipe (not shown in the figures), and the cover 40 close the water hammer water hammer pipe 10.

According to the present invention, the movable water plugs 20, in a preferred embodiment, is further sleeved with several water-stop rubber rings 21 used to increase the airtightness of the internal space of the water hammer tube 10.

Furthermore, the joint 30, cover 40 of the present invention, according to the material of the water hammer pipe 10, may be connected to the water hammer pipe by means of rotary welding (plastics), welding (metal material), or screwing (physical connection).

Furthermore, the joint 30 of the present invention may be a structure with internal threads or external threads, or it may be provided with a turn part 31, which makes it convenient to be turned with a tool or wrench.

Referring to FIGS. 1 to 3 again, the water hammer pipe is provided with a bottom wall 11 on the side opposite to the joint 30, and the bottom wall 11 is provided with a mounting hole 12 and a plurality of filling holes 13. Furthermore, the inside of the water hammer pipe 10 is assembled with a non-return diaphragm 50 adapted to shield the filling hole 13 of the bottom wall 11 of the water hammer pipe 10, where the non-return diaphragm 50 is provided with a rod 51 configured on the mounting hole 12.

Referring to FIGS. 1 to 3 once again, high-pressure air is removed after injected into the internal space of the water hammer pipe 10 from the plurality of filling holes, allowing the internal part of the water hammer pipe 10 to generate high pressure to attach to the non-return diaphragm 50 to cover the bottom wall 11 and the plurality of filling holes, thereby preventing the high-pressure air from leaking out, and closing the side having the non-return diaphragm 50 to strengthen the airtightness of the internal space.

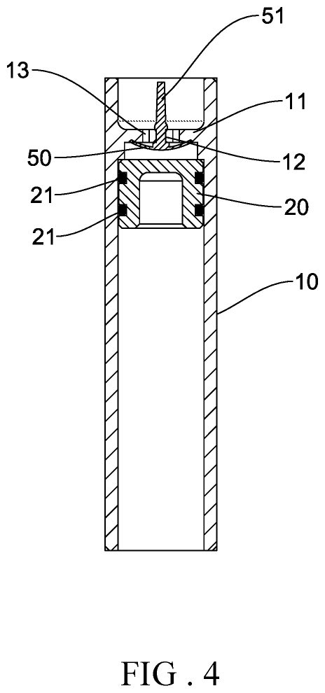

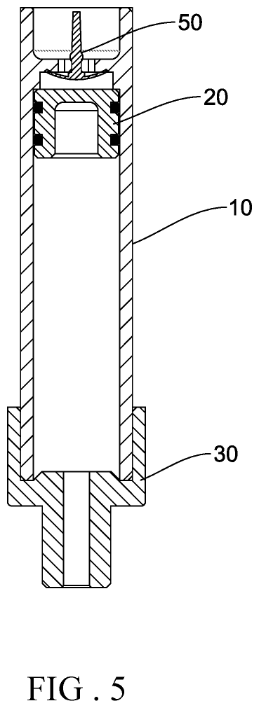

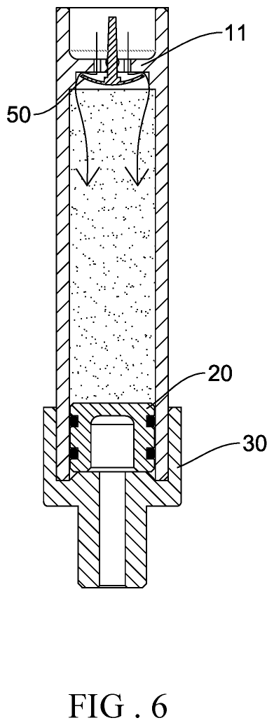

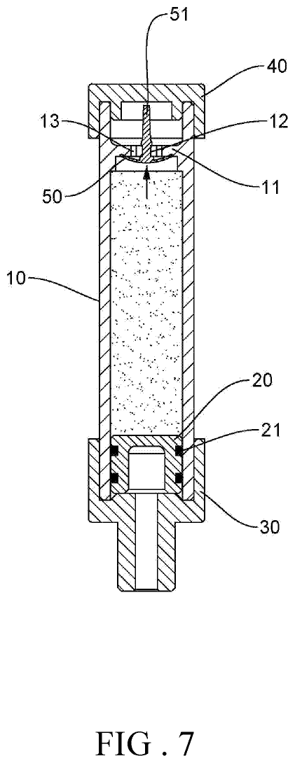

The above is the introduction of each part of the present invention, and the following will introduce the assembly method of the present invention and the advantages that can be obtained:
Step 1: inserting non-return diaphragm 50 into the water hammer pipe 10 from the side thereof opposite to the bottom wall 11, and engaging the rod 51 of the non-return diaphragm 50 in the mounting hole 12 as FIG. 4 shows;
Step 2: inserting the movable water plug 20 into the water hammer pipe 10 from the side opposite to the bottom wall 11 as FIG. 4 shows, where Step 1 and Step 2 can be integrated in the same step;
Step 3: assembling and fixing the joint 30 to the side of the water hammer pipe opposite to the bottom wall 11 as FIG. 5 shows, where the joint 30 can be coupled to the water hammer pipe 10 by means of the assembly way mentioned above;
Step 4: injecting high-pressure air into the interspace of the water hammer pipe from the plurality of filling holes 13, and thereafter, removing the high-pressure air from the plurality of filling holes 13, allowing the internal space to generate an air chamber effect to cause the non-return diaphragm 50 to be deformed to attach to the bottom wall 11 as FIG. 6 shows, preventing the high-pressure air of the internal space form leaking out; and
Step 5: assembling and fixing the cover 40 to the side of the water hammer pipe opposite to the joint 30 as FIG. 7 shows, so that the assembly of the water hammer absorption device can then be completed.

With the design of the present invention, using the non-return diaphragm to replace the original air nozzle allows the water hammer absorption device to have no exposed air nozzle, thereby preventing operation collision to damage. In addition, the non-return diaphragm is low in cost and easy in assembly, and can greatly simplify the structure of the water hammer absorption device.

I claim:

1. A water hammer absorption device, provided with a movable water plug slidable inside a water hammer pipe, both ends of said water hammer pipe respectively in connection with a joint and cover, said joint adapted to be connected with a connecting pipe, and said cover closing said water hammer pipe, characterized in that:
a bottom wall is provided inside the side of said water hammer pipe opposite to said joint, said bottom wall is provided with a mounting hole and a plurality of filling holes, a non-return diaphragm is assembled inside said water hammer pipe, said non-return diaphragm is adapted to shield said filling holes of said bottom wall of said water hammer pipe, and said non-return diaphragm is provided with a rod configured in said mounting hole;
high-pressure air is removed after injected into an internal space of said water hammer pipe, allowing high pressure to be generated inside said water hammer pipe, and said non-return diaphragm to attach to and cover said bottom wall and said plurality of filling holes, preventing said high-pressure air from leaking out, and closing the side of said water hammer pipe having non-return diaphragm through said cover, thereby strengthening the airtightness of said internal space.

2. The device according to claim 1, wherein said movable water plug is sleeved with a plurality of water-stop rubber rings.

3. The device according to claim 1, wherein said joint is connected to said water hammer pipe by means of rotary welding, welding or screwing.

4. The device according to claim 1, wherein said joint is provided with a turn part allowing said joint to be turned to fix to said connecting pipe with a wrench or tool.

5. A method for manufacturing the water hammer absorption device according to claim 1, comprising the following steps:
inserting non-return diaphragm into said water hammer pipe from the side thereof opposite to said bottom wall, and sleeving said rod of said non-return diaphragm in said mounting hole;
inserting said movable water plug into the water hammer pipe from the side opposite to said bottom wall;
assembling and fixing said joint to the side of said water hammer pipe opposite to said bottom wall;
injecting high-pressure air into the interspace of said water hammer pipe from said plurality of filling holes, and thereafter, removing said high-pressure air from said plurality of filling holes, allowing the internal space to generate an air chamber effect to cause said non-return diaphragm to be deformed to attach to said bottom wall, preventing said high-pressure air of the internal space form leaking out; and
assembling and fixing the cover to the side of said water hammer pipe opposite to the joint, so that the assembly of the water hammer absorption device can then be completed.
